(19) United States
(12) Patent Application Publication
(10) Pub. No.: US 2023/0119654 A1
(43) Pub. Date: Apr. 20, 2023

(54) Identifying Node Importance in Machine Learning Pipelines

(71) Applicant: International Business Machines Corporation, Armonk, NY (US)

(72) Inventors: Jin Wang, Xi'an (CN); Lei Gao, Xi'an (CN); Kai Li, Xi'an (CN); A Peng Zhang, Xi'an (CN); Yan Liu, Xi'an (CN); Jia Xing Tang, Xi'an (CN); Xin Feng Zhu, Xi'an (CN)

(21) Appl. No.: 17/451,495

(22) Filed: Oct. 20, 2021

(51) Int. Cl. G06N 20/00

(52) U.S. Cl. CPC G06N 20/00

(57) ABSTRACT

Identifying node importance in a machine learning pipeline is provided. Changes in accuracy of the machine learning pipeline are recorded for each respective node setting change in a randomly generated group of node settings inputted into each corresponding node included in the machine learning pipeline. A regression model is generated to determine a relationship between each respective node setting change in the randomly generated group of node settings inputted into each corresponding node and the changes in the accuracy of the machine learning pipeline. A node of importance is identified in the machine learning pipeline using the regression model based on the relationship between each respective node setting change in the randomly generated group of node settings inputted into each corresponding node and the changes in the accuracy of the machine learning pipeline.

### BACKGROUND

### 1. Field

The disclosure relates generally to machine learning and more specifically to identifying node importance in a machine learning pipeline by vectorizing groups of node setting changes corresponding to a plurality of nodes included in the machine learning pipeline to acquire a relationship between the node setting changes and impact on accuracy and performance of the machine learning pipeline.

### 2. Description of the Related Art

Machine learning involves inputting data to a process and allowing the process to adjust and improve automatically over time through experience, thereby increasing predictive accuracy of the machine learning model and, thus, increasing performance of the data processing system, itself. Unsupervised machine learning is an ability to find patterns in a stream of input, without requiring a human to label the inputs first. Supervised machine learning includes both classification and regression, which requires a human to label the input data first, known as training data, in order to make predictions, estimations, decisions, or the like without being explicitly programmed to do so. Classification is used to determine what category something belongs in, and occurs after a machine learning program sees a number of examples of things from several categories. Regression is the attempt to produce a function that describes the relationship between inputs and outputs and predicts how the outputs should change as the inputs change.

A machine learning model can learn using various types of machine learning algorithms. The machine learning algorithms include at least one of supervised learning, unsupervised learning, semi-supervised learning, feature learning, sparse dictionary learning, association rules, or other types of learning algorithms. Examples of machine learning models include an artificial neural network, a decision tree, a support vector machine, a Bayesian network, a genetic algorithm, and other types of models.

### SUMMARY

According to one illustrative embodiment, a computer-implemented method for identifying node importance in a machine learning pipeline is provided. A computer records changes in accuracy of the machine learning pipeline for each respective node setting change in a randomly generated group of node settings inputted into each corresponding node included in the machine learning pipeline. The computer generates a regression model to determine a relationship between each respective node setting change in the randomly generated group of node settings inputted into each corresponding node and the changes in the accuracy of the machine learning pipeline. The computer identifies a node of importance in the machine learning pipeline using the regression model based on the relationship between each respective node setting change in the randomly generated group of node settings inputted into each corresponding node and the changes in the accuracy of the machine learning pipeline. According to other illustrative embodiments, a computer system and computer program product for identifying node importance in a machine learning pipeline are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a machine learning pipeline in accordance with an illustrative embodiment;

FIG. 4 is a diagram illustrating an example of a groups of node settings table in accordance with an illustrative embodiment;

FIG. 5 is a diagram illustrating an example of a machine learning pipeline accuracy table in accordance with an illustrative embodiment;

FIG. 6 is a flowchart illustrating a process for identifying node importance in a machine learning pipeline in accordance with an illustrative embodiment; and

FIGS. 7A-7B are a flowchart illustrating a process for implementing a node setting change on a node of importance in a machine learning pipeline in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

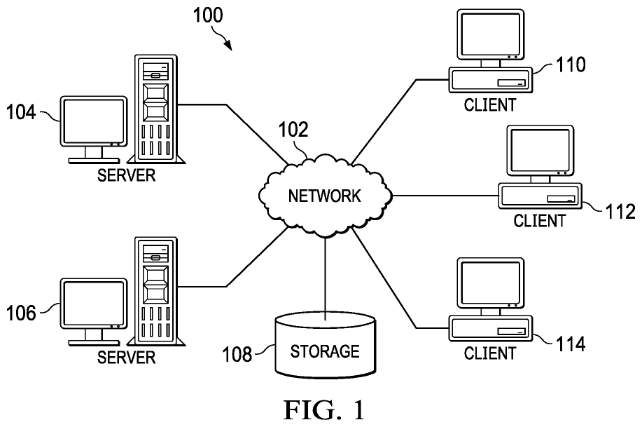

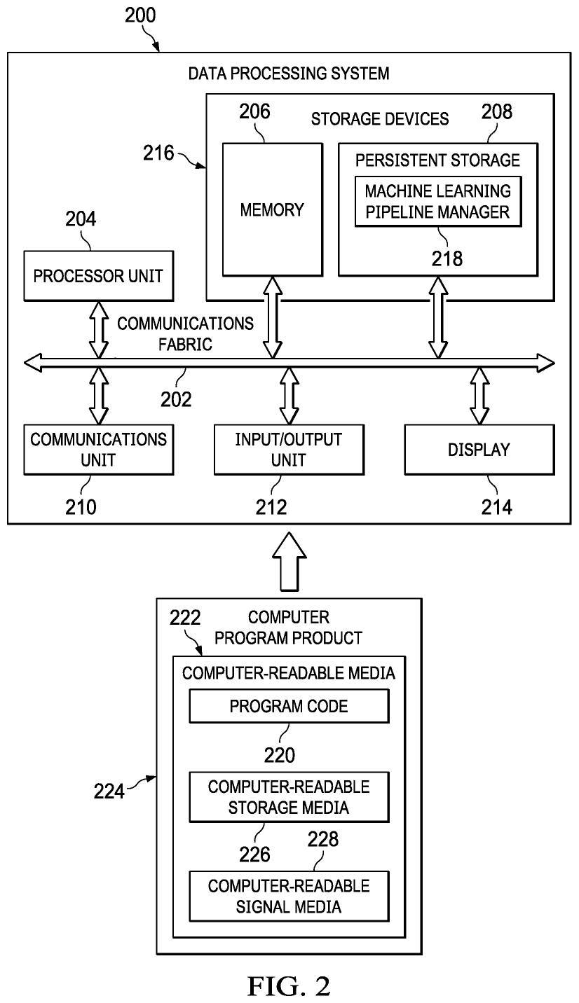

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, physical server computers with high-speed connections to network 102. In addition, server 104 and server 106 may each represent a cluster of servers in one or more data centers. Alternatively, server 104 and server 106 may each represent multiple computing nodes in one or more cloud environments. Further, server 104 and server 106 may include a number of virtual machines.

In this example, server 104 represents a plurality of physical and virtual nodes in a machine learning pipeline that transforms incoming data in order to generate predictions or estimations on the data by a set of machine learning models included in the machine learning pipeline. The machine learning pipeline may, for example, correspond to a business process or service, such as an event monitoring process, financial process, banking process, governmental process, educational process, data analytics process, or the like. A client device user may use the machine learning pipeline to obtain predictions on data corresponding to the business process in order to take appropriate action if needed.

Server 106 represents a number of servers that provides machine learning pipeline management services to optimize machine learning pipelines by increasing accuracy and performance of machine learning pipelines. Server 106 determines a relationship between changes in node settings corresponding to nodes comprising a machine learning pipeline and changes in accuracy and performance of the machine learning pipeline to identify node importance in the machine learning pipeline. An important node in a machine learning pipeline is a node that uses a decreased amount of data, while increasing accuracy and performance of the machine learning pipeline after that node. As a result, that particular node has an increased level of importance in that particular machine learning pipeline with regard to the accuracy and performance of that particular machine learning pipeline as opposed to other nodes in that pipeline.

Server 106 vectorizes node setting changes corresponding to the nodes comprising the machine learning pipeline to acquire the relationship between the changes in the node settings and the impact on the accuracy and performance of the machine learning pipeline to identify the node of importance in the machine learning pipeline. By determining node importance within the machine learning pipeline, server 106 can enable a user to focus on a specific business process within the machine learning pipeline. In addition, server 106 can automatically implement a node setting change on the identified node of importance that caused an increase in accuracy and performance of the machine learning pipeline. A client device user, such as, for example, a system administrator, can request server 106 to optimize a particular machine learning pipeline to increase accuracy and performance of that particular machine learning pipeline.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Users of clients 110, 112, and 114 may utilize clients 110, 112, and 114 to access and utilize the services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for servers comprising machine learning pipelines, identifiers and network addresses for a plurality of different client devices, identifiers for a plurality of different client device users, machine learning models, regression models, node settings, recorded machine learning pipeline accuracy changes, and the like. Furthermore, storage 108 may store other types of data, such as authentication or credential data that may include usernames, passwords, and the like associated with client device users, for example.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 106 and downloaded to server 104 over network 102 for use on server 104.

In the depicted example, network data processing system 100 may be implemented as a number of different types of communication networks, such as, for example, an internet, an intranet, a wide area network (WAN), a local area network (LAN), a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 106 in FIG. 1, in which computer-readable program code or instructions implementing the machine learning pipeline management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores machine learning pipeline manager 218. However, it should be noted that even though machine learning pipeline manager 218 is illustrated as residing in persistent storage 208, in an alternative illustrative embodiment, machine learning pipeline manager 218 may be a separate component of data processing system 200. For example, machine learning pipeline manager 218 may be a hardware component coupled to communication fabric 202 or a combination of hardware and software components.

Machine learning pipeline manager 218 controls the process of determining a relationship between changes in node settings of nodes comprising a machine learning pipeline and changes in accuracy and performance of the machine learning pipeline to identify node importance in the machine learning pipeline. Machine learning pipeline manager 218 vectorizes node setting changes corresponding to the nodes comprising the machine learning pipeline to acquire the relationship between the changes in the node settings and the impact on the accuracy and performance of the machine learning pipeline to identify a node of importance in the machine learning pipeline. By determining node importance within the machine learning pipeline, machine learning pipeline manager 218 can enable a user to focus on specific business processes of interest within the machine learning pipeline. In addition, machine learning pipeline manager 218 can automatically implement a node setting change, which caused the increase in accuracy and performance of the machine learning pipeline, on the node of importance.

As a result, data processing system 200 operates as a special purpose computer system in which machine learning pipeline manager 218 in data processing system 200 enables optimization of machine learning pipelines by identifying node importance within the machine learning pipelines. In particular, machine learning pipeline manager 218 transforms data processing system 200 into a special purpose computer system as compared to currently available general computer systems that do not have machine learning pipeline manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 220 is located in a functional form on computer-readable media 222 that is selectively removable and may be loaded onto or transferred to data processing system 200 for running by processor unit 204. Program code 220 and computer-readable media 222 form computer program product 224. In one example, computer-readable media 222 may be computer-readable storage media 226 or computer-readable signal media 228.

In these illustrative examples, computer-readable storage media 226 is a physical or tangible storage device used to store program code 220 rather than a medium that propagates or transmits program code 220. Computer-readable storage media 226 may include, for example, an optical or magnetic disc that is inserted or placed into a drive or other device that is part of persistent storage 208 for transfer onto a storage device, such as a hard drive, that is part of persistent storage 208. Computer-readable storage media 226 also may take the form of a persistent storage, such as a hard drive, a thumb drive, or a flash memory that is connected to data processing system 200.

Alternatively, program code 220 may be transferred to data processing system 200 using computer-readable signal media 228. Computer-readable signal media 228 may be, for example, a propagated data signal containing program code 220. For example, computer-readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 222” can be singular or plural. For example, program code 220 can be located in computer-readable media 222 in the form of a single storage device or system. In another example, program code 220 can be located in computer-readable media 222 that is distributed in multiple data processing systems. In other words, some instructions in program code 220 can be located in one data processing system while other instructions in program code 220 can be located in one or more other data processing systems. For example, a portion of program code 220 can be located in computer-readable media 222 in a server computer while another portion of program code 220 can be located in computer-readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Machine learning pipelines are becoming more and more complex day by day. For example, more than a hundred nodes can exist in one machine learning pipeline, especially in complex business processes. In addition, a machine learning pipeline can include a multitude of different business logics. However, identifying which node is most important, influential, or significant in a machine learning pipeline is not an easy task.

Further, a machine learning pipeline can include a high percentage of transformation nodes (e.g., extract, transform, load nodes) in a complex business process to transform the data before machine learning model building can occur. A transformation node can, for example, modify data values. In some cases, transformation nodes can comprise up to 90% of a machine learning pipeline. As a result, identification of important nodes within a machine learning pipeline is necessary for a user to understand which node or set of nodes can be changed to achieve user-desired results (e.g., a machine learning pipeline with increased accuracy and performance using a decreased amount of data and computing resources).

Current machine learning pipelines involving complex business processes include a multitude of nodes, which are typically created by specialists who are familiar with these complex business processes and machine learning technologies. For such a specialist, it may be relatively easy to create a machine learning pipeline but may not be so easy for the specialist to convey which node or set of nodes are most important in the machine learning pipeline. Further, for a person who is not familiar with the complex business processes or machine learning technologies, it may be difficult for that person to analyze a machine learning pipeline and then determine which node or nodes in the machine learning pipeline are important. This can lead to situations where users cannot identify which node or nodes in the machine learning pipeline are most important and how to change settings of those nodes to meet user-desired goals of increasing machine learning model accuracy and performance with decreased effort.

Illustrative embodiments determine the relationship between changes in node settings and changes in machine learning pipeline accuracy and performance to identify node importance in the machine learning pipeline. By illustrative embodiments determining node importance within a machine learning pipeline, illustrative embodiments enable a user to focus on special areas (e.g., specific business processes of interest) within the machine learning pipeline.

Illustrative embodiments divide a machine learning pipeline into a plurality of branches. Then, illustrative embodiments randomly generate a group of node settings for each respective node in each branch of the machine learning pipeline and input each randomly generated group of node settings into each corresponding node. Illustrative embodiments record changes in accuracy and performance of the machine learning pipeline for each respective node setting change in the group of node settings corresponding to each particular node in a branch.

Afterward, illustrative embodiments generate a regression model to determine a relationship between each respective node setting change in the group of node settings corresponding to each node and the recorded changes in the accuracy and performance of the machine learning pipeline. Illustrative embodiments identify a node of importance in the machine learning pipeline using the regression model based on the determined relationship between each respective node setting change in the group of node settings corresponding to each node and the recorded changes in the accuracy of the machine learning pipeline.

By determining the relationship between node setting changes and changes in machine learning pipeline accuracy and performance, illustrative embodiments can identify a node of importance in the machine learning pipeline to build a machine learning model with increased accuracy and performance. Illustrative embodiments can then automatically implement the node setting change on the node of importance that caused the increase in accuracy and performance of the machine learning pipeline.

Thus, illustrative embodiments provide one or more technical solutions that overcome a technical problem with identifying node importance in a machine learning pipeline to build a machine learning model with increased accuracy and performance. As a result, these one or more technical solutions provide a technical effect and practical application in the field of machine learning.

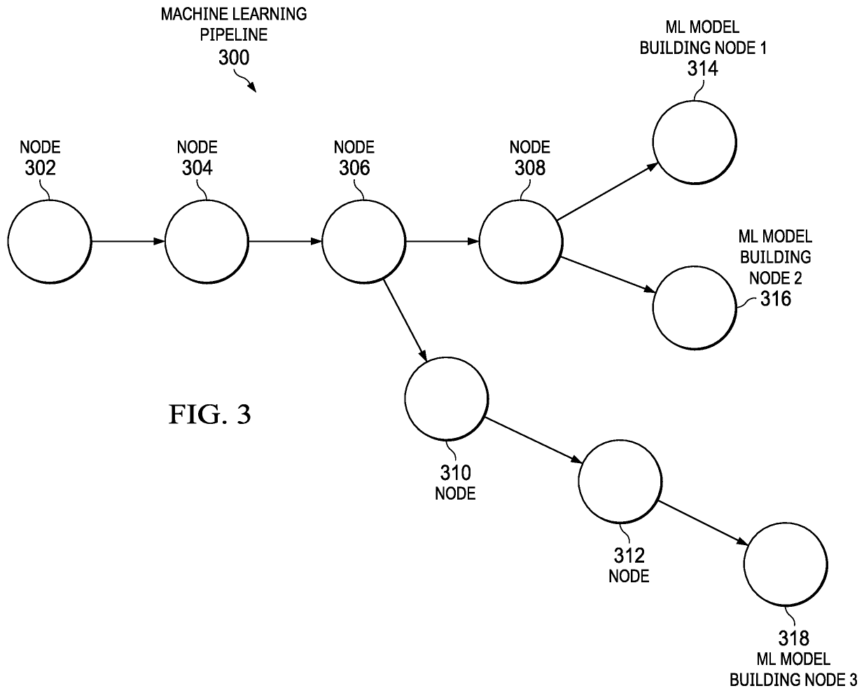

With reference now to FIG. 3, a diagram illustrating an example of a machine learning pipeline is depicted in accordance with an illustrative embodiment. Machine learning pipeline 300 may be implemented in a network of data processing systems, such as network data processing system 100 in FIG. 1. Machine learning pipeline 300 is comprised of a plurality of nodes, which can include physical or virtual machines, that performs transformations on inputted data in order to generate predictions or estimations on the data by a set of machine learning models in the machine learning pipeline.

In this example, machine learning pipeline 300 includes node 302, node 304, node 306, node 308, node 310, node 312, machine learning model building node 1 314, machine learning model building node 2 316, and machine learning model building node 3 318. However, it should be noted that machine learning pipeline 300 is intended as an example only and not as a limitation on illustrative embodiments. In other words, machine learning pipeline 300 may include any number and type of nodes. A machine learning model building node is a node in machine learning pipeline 300 that generates a machine learning model to process the transformed data received from previous nodes to make predictions or estimations on the data.

A machine learning pipeline manager, such as, for example, machine learning pipeline manager 218 in FIG. 2, identifies all branches within machine learning pipeline 300. In this example, the machine learning pipeline manager regards each of machine learning model building node 314, machine learning model building node 2 316, and machine learning model building node 3 318 as being a part of one branch of machine learning pipeline 300.

Further, the machine learning pipeline manager utilizes a default node weight value of 1 for each respective node included in each branch of machine learning pipeline 300. The machine learning pipeline manager also counts the number of nodes connected to each particular machine learning model building node in machine learning pipeline 300 for determining a total branch weight value for each particular branch. Furthermore, if a particular node is connected to more than 1 machine learning model building node via different branches in machine learning pipeline 300, then the machine learning pipeline manager determines the weight value for that particular node as 1/(actual number of machine learning model building nodes that particular node is connected to).

In this example, machine learning pipeline 300 is comprised of 9 nodes. Also in this example, it should be noted that 3 of the 9 nodes are machine learning model building nodes (e.g., machine learning model building node 1 314, machine learning model building node 2 316, and machine learning model building node 3 318). Consequently, the machine learning pipeline manager divides machine learning pipeline 300 into 3 separate branches.

Further in this example, node 302, node 304, and node 306 are commonly connected to machine learning model building node 1 314, machine learning model building node 2 316, and machine learning model building node 3 318 via the 3 branches of machine learning pipeline 300. As a result, the machine learning pipeline manager calculates the node weight value for each of node 302, node 304, and node 306 as ⅓, ⅓, and ⅓, respectively. The node weight value of the remaining nodes (e.g., node 308, node 310, node 312, machine learning model building node 1 314, machine learning model building node 2 316, and machine learning model building node 3 318) in machine learning pipeline 300 is the default node weight value of 1.

In this example, the machine learning pipeline manager calculates the branch weight value of the entire branch corresponding to machine learning model building node 1 314, which consists of 5 nodes (e.g., node 302, node 304, node 306, node 308, and machine learning model building node 1 314), as the sum of the 5 individual node weights divided by the total number of nodes (e.g., 9) in machine learning pipeline 300 or ⅓+⅓+⅓+1+ 1/9, which is equal to 0.33 the branch weight value for that particular branch. The machine learning pipeline manager also calculates the branch weight value of the branch corresponding to machine learning model building node 2 316, which also consists of 5 nodes (e.g., node 302, node 304, node 306, node 308, and machine learning model building node 2 316), as the sum of the 5 individual node weights divided by the total number of nodes (e.g., 9) in machine learning pipeline 300 or ⅓+⅓+⅓+1+ 1/9, which is equal to 0.33 the branch weight value for that particular branch. In addition, the machine learning pipeline manager calculates the branch weight value of the branch corresponding to machine learning model building node 3 318, which consists of 6 nodes (e.g., node 302, node 304, node 306, node 310, node 312, and machine learning model building node 3 318), as the sum of the 6 individual node weights divided by the total number of nodes (e.g., 9) in machine learning pipeline 300 or ⅓+⅓+⅓+1+1+ 1/9, which is equal to 0.44 the branch weight value for that particular branch.

Further, the machine learning pipeline manager randomly generates a plurality of different groups of node settings for each branch of nodes in machine learning pipeline 300. For example, if a particular branch includes “N” number of nodes (e.g., 6), then the machine learning pipeline manager randomly generates at least 3*N (e.g., 3*6 or 18) different groups of node setting data for each respective branch of nodes in machine learning pipeline 300 in order to obtain enough data to build a regression model (e.g., relationship model). It should be noted that the regression model will be more accurate for determining relationships using more data. In other words, the machine learning pipeline manager can generate X*N number of different groups of node setting data, where X is greater than 3.

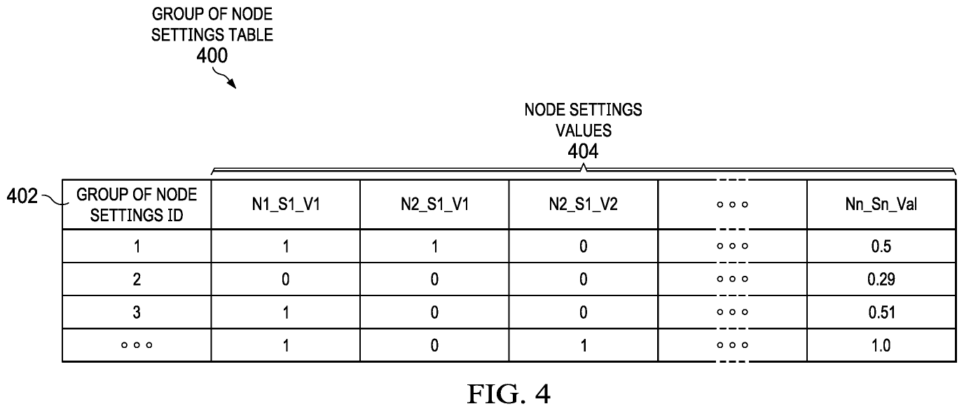

With reference now to FIG. 4, a diagram illustrating an example of a groups of node settings table is depicted in accordance with an illustrative embodiment. Groups of node settings table 400 may be implemented in a machine learning pipeline manager, such as, for example, machine learning pipeline manager 218 in FIG. 2.

In this example, groups of node settings table 400 includes group of node settings identifier 402 and node settings values 404. Group of node settings identifier 402 uniquely identifies each particular group of randomly generated node settings for nodes comprising a machine learning pipeline, such as, for example, machine learning pipeline 300 in FIG. 3. Node settings values 404 show the values for settings of respective nodes. For example, “N1 S1 V1” represents node 1, setting 1 for node 1, and value 1 for setting 1 of node 1; “N2 S1 V1” represents node 2, setting 1 for node 2, and value 1 for setting 1 of node 2; “N2 S1 V2” represents node 2, setting 1 for node 2, and value 2 for setting 1 of node 2; and “Nn Sn Val” represents node n, setting n for node n, and value for setting n of node n.

The machine learning pipeline manager inputs the different groups of node settings into corresponding nodes of the machine learning pipeline. The machine learning pipeline manager records changes in accuracy and performance of the machine learning pipeline for each group of node settings input into corresponding nodes of a particular branch in the machine learning pipeline. It should be noted that the machine learning pipeline manager changes the node settings for each respective node in a branch.

First, the machine learning pipeline manager determines a numeric range for all randomly generated numeric node settings for a branch of nodes. The machine learning pipeline manager can normalize the randomly generated numeric value for each respective node for convenience. For example, the machine learning pipeline manager may determine the numeric range for all randomly generated data corresponding to node settings for one branch of nodes may be, for example, from 120-250. The machine learning pipeline manager randomly generates a numeric value (e.g., 148), which is within the determined numeric range, for a particular node in the branch. The machine learning pipeline manager can then normalize the randomly generated numeric value of 148 for that particular node as (148−120)/(250−120)=0.215.

For a categorical node setting, the machine learning pipeline manager can determine a list of items with measurement levels. A categorical node setting can correspond to any type of item with a measurement level predefined by a user. The machine learning pipeline manager selects from these items to generate several fields and make the corresponding value a 1 or 0. For example, a categorical setting can include 3 choices, such as A, B, or C. The machine learning pipeline manager can then transform the categorical setting to 3 columns, such as element_A, element_B, and element_C. Each column has a value of 1 or 0. For example, if the user selects B, then the column values will be (0,1,0). Similarly, if the user selects A and B, then the column values will be (1,1,0).

It should be noted that some input node settings, which are not directly listed for selection, need to be extended to categorical settings and be continuously input from its original source. For example, for input data column names, such as, for example, job, salary, age, and the like, the machine learning pipeline manager can extend these input node settings to categorical settings, such as, for example, datatype, statical information, or the like. The machine learning pipeline manager can then similarly utilize these extended columns as above.

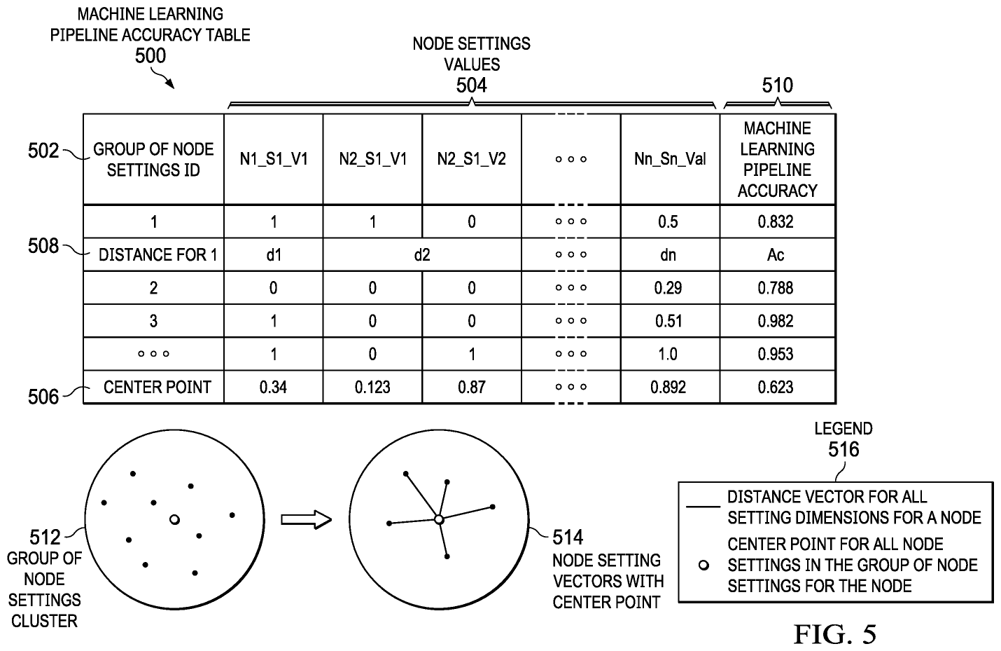

With reference now to FIG. 5, a diagram illustrating an example of a machine learning pipeline accuracy table is depicted in accordance with an illustrative embodiment. Machine learning pipeline accuracy table 500 may be implemented in a machine learning pipeline manager, such as, for example, machine learning pipeline manager 218 in FIG. 2.

In this example, machine learning pipeline accuracy table 500 includes group of node settings identifier 502 and node settings values 504, such as, for example, node settings identifier 402 and node settings values 404 in FIG. 4. Machine learning pipeline accuracy table 500 also includes center point 506, distance 508, and machine learning pipeline accuracy 510. Center point 506 represents a calculated center point corresponding to different node settings for a particular node included in a branch of a machine learning pipeline, such as, for example, machine learning pipeline 300 in FIG. 3. Distance 508 represents a vector distance from center point 506 for a respective node setting of a particular node. Machine learning pipeline accuracy 510 represents a change in accuracy of the machine learning pipeline based on distance 508 from center point 506 for a particular node setting.

FIG. 5 also includes group of node settings cluster 512, node setting vectors with center point 514, and legend 516. Group of node settings cluster 512 represents an example of a cluster of node settings for a particular node. Node setting vectors with center point 514 represents vectorization of the cluster of node settings in group of node settings cluster 512. Legend 516 is a legend for node setting vectors with center point 514 to clarify the diagram.

After the machine learning pipeline manager generates a group of node settings for each respective node in a branch of the machine learning pipeline, the machine learning pipeline manager calculates the center point of a cluster corresponding to the group of node settings for each respective node in order to determine the change in accuracy of the machine learning pipeline. The machine learning pipeline manager transforms each node setting into a vector. The machine learning pipeline manager uses the group of node settings for each respective node as one cluster. The machine learning pipeline manager then calculates the center point of each cluster. In addition, the machine learning pipeline manager uses the center point of a cluster as a base accuracy value for the machine learning pipeline for determining the change in accuracy of the machine learning pipeline corresponding to that node. Each node setting has one vector distance between the center point of the cluster and itself. Also, each node setting will have one machine learning pipeline accuracy value corresponding to it.

After the machine learning pipeline manager calculates the distance value for each node setting, the machine learning pipeline manager utilizes the distance values to build a regression model that shows the relationship between respective node setting changes in the group of node settings corresponding to each node and recorded changes in the accuracy and performance of the machine learning pipeline. The regression model forms new data, which is a Euclidean distance, for each node corresponding to one group of node settings. Distance 508 is an example that shows the distance between group of node settings 1 and the center point of its cluster. It should be noted that each respective group of node settings will have a similar format.

The machine learning pipeline manager builds the regression model to reflect the relationship between node setting changes and machine learning pipeline accuracy changes. The machine learning pipeline manager builds the regression model using the distance values in 508 of machine learning pipeline accuracy table 500. The machine learning pipeline manager calculate machine learning pipeline accuracy 510 utilizing the following equation:

$${\sum }_{t = 1}^{N} {β}_{t} * {d}_{t} = Ac$$

where βₜ is the coefficient of change between node settings and machine learning pipeline accuracy for node i, dᵢ is the vector distance between the node settings and the center point (base machine learning pipeline accuracy value) for node i, and Ac is the change in accuracy from the base machine learning pipeline accuracy value for one group of settings. For all randomly generated node settings (default is 3*N), the machine learning pipeline manager calculates an initial coefficient of change (βₜ) beta value for each particular node in a branch using, for example, a least squares method. The machine learning pipeline manager utilizes the calculated initial coefficient of change beta value for each particular node in the branch as an initial node importance value for that particular node.

The machine learning pipeline manager multiples the calculated initial node importance value for each respective node in a branch with the branch weight value for that particular branch of nodes. The initial node importance value can reflect the impact of changes in node settings on the changes in machine learning pipeline accuracy 510. The machine learning pipeline manager calculates the final node importance value (NI) for each respective node in the branch using the following equation:

$$NI = {\sum }_{t = 1}^{M} Initial {β}_{t} * {w}_{t}$$

where Intialβₜ is the calculated initial node importance beta value for one node in a particular branch of the machine learning pipeline and wₜ is the calculated weight of that particular branch. Using the equation above, the machine learning pipeline manager obtains a final node importance value for each respective node in the branch. It should be noted that the machine learning pipeline manager can normalize the initial node importance beta values to a 0 or 1. In addition, if a particular node is not included in all branches of the machine learning pipeline, then the machine learning pipeline manager can calculate a new branch weight corresponding to branches that include that particular node using the equation:

$${neww}_{t} = \frac{{w}_{t}}{sum of {w}_{t} for all branches node ts included tn} .$$

The machine learning pipeline manager then determines the node of importance in the machine learning pipeline based on the final node importance value for each node in the branch. The machine learning pipeline manager selects the node having the greatest final node importance value as the node of importance in the machine learning pipeline. The machine learning pipeline manager can substitute the accuracy of the machine learning pipeline with execution time so that the target of node importance is now performance of the machine learning pipeline. Even though the machine learning pipeline manager can optimize the machine learning pipeline by increasing machine learning pipeline accuracy and performance, the machine learning pipeline manager can also target other indicators of the machine learning pipeline that can be impacted by changing node settings.

Further, the machine learning pipeline manager can use node importance values to automatically filter out nodes, which have node importance values less than a defined minimum node importance value threshold and do not significantly contribute to the machine learning building process, from the machine learning pipeline. Furthermore, the machine learning pipeline manager can automatically increase a weight value of a particular node, which is important to several other nodes following that particular node in the machine learning pipeline, in order to optimize the machine learning pipeline and/or assist a user in optimizing the entire machine learning pipeline.

Thus, by calculating node importance values for all nodes in the machine learning pipeline, the machine learning pipeline manager can provide a user with an increased understanding of the impact that each particular node in the machine learning pipeline has on the accuracy and performance of the machine learning pipeline. In addition, based on the calculated weight of different branches in the machine learning pipeline, the machine learning pipeline manager can combine machine learning models in the machine learning pipeline to form one node of importance that is more comprehensive.

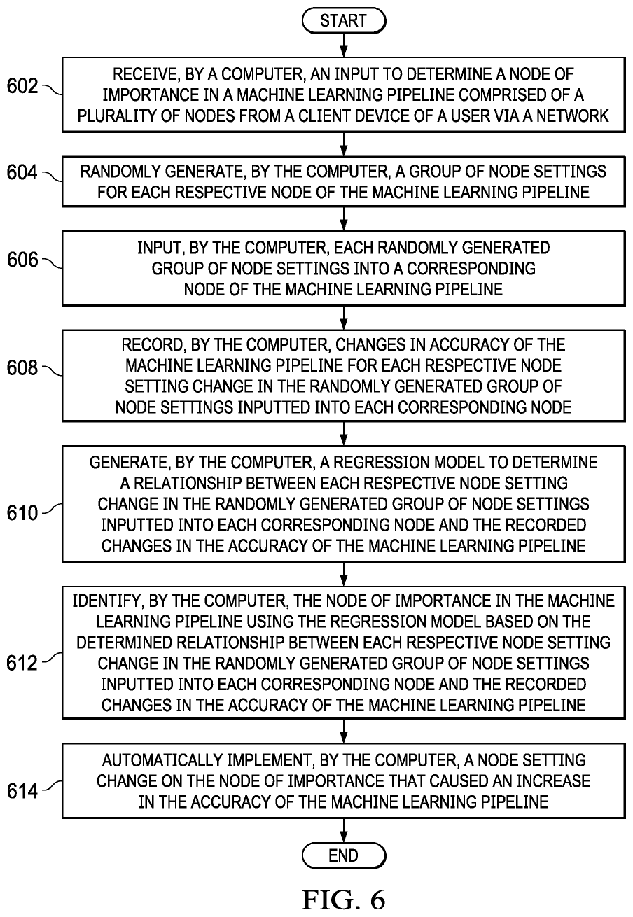

With reference now to FIG. 6, a flowchart illustrating a process for identifying node importance in a machine learning pipeline is shown in accordance with an illustrative embodiment. The process shown in FIG. 6 may be implemented in a computer, such as, for example, server 106 in FIG. 1 or data processing system 200 in FIG. 2. For example, the process shown in FIG. 6 may be implemented in machine learning pipeline manager 218 in FIG. 2.

The process begins when the computer receives an input to determine a node of importance in a machine learning pipeline comprised of a plurality of nodes from a client device of a user via a network (step 602). In response to receiving the input to determine the node of importance in the machine learning pipeline, the computer randomly generates a group of node settings for each respective node of the machine learning pipeline (step 604). The computer inputs each randomly generated group of node settings into a corresponding node of the machine learning pipeline (step 606).

The computer records changes in accuracy of the machine learning pipeline for each respective node setting change in the randomly generated group of node settings inputted into each corresponding node (step 608). The computer generates a regression model to determine a relationship between each respective node setting change in the randomly generated group of node settings inputted into each corresponding node and the recorded changes in the accuracy of the machine learning pipeline (step 610).

The computer identifies the node of importance in the machine learning pipeline using the regression model based on the determined relationship between each respective node setting change in the randomly generated group of node settings inputted into each corresponding node and the recorded changes in the accuracy of the machine learning pipeline (step 612). The computer automatically implements a node setting change on the node of importance that caused an increase in the accuracy of the machine learning pipeline (step 614). Thereafter, the process terminates.

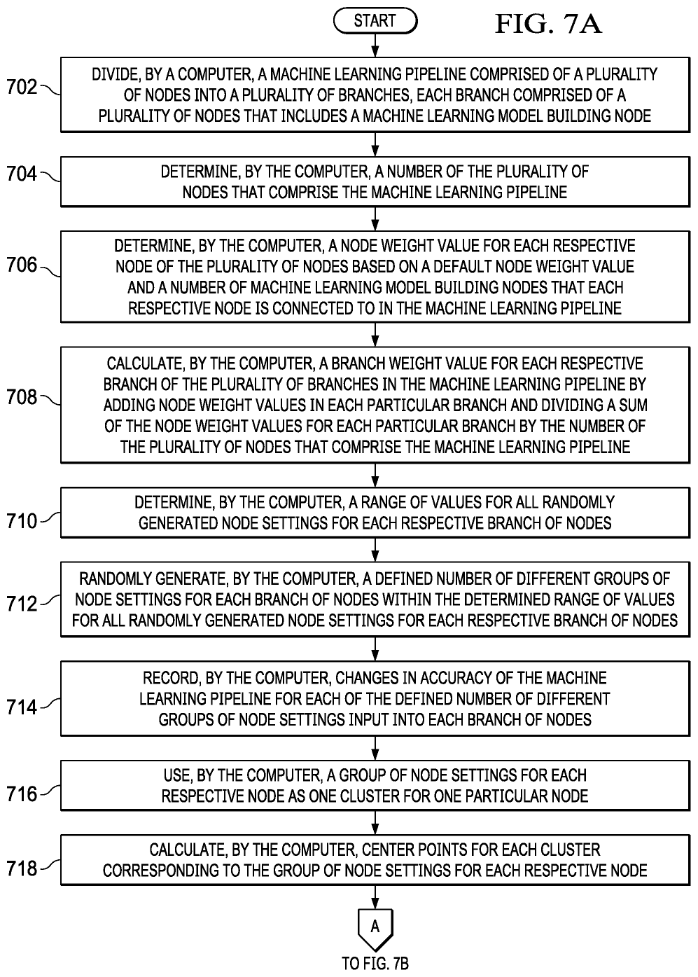

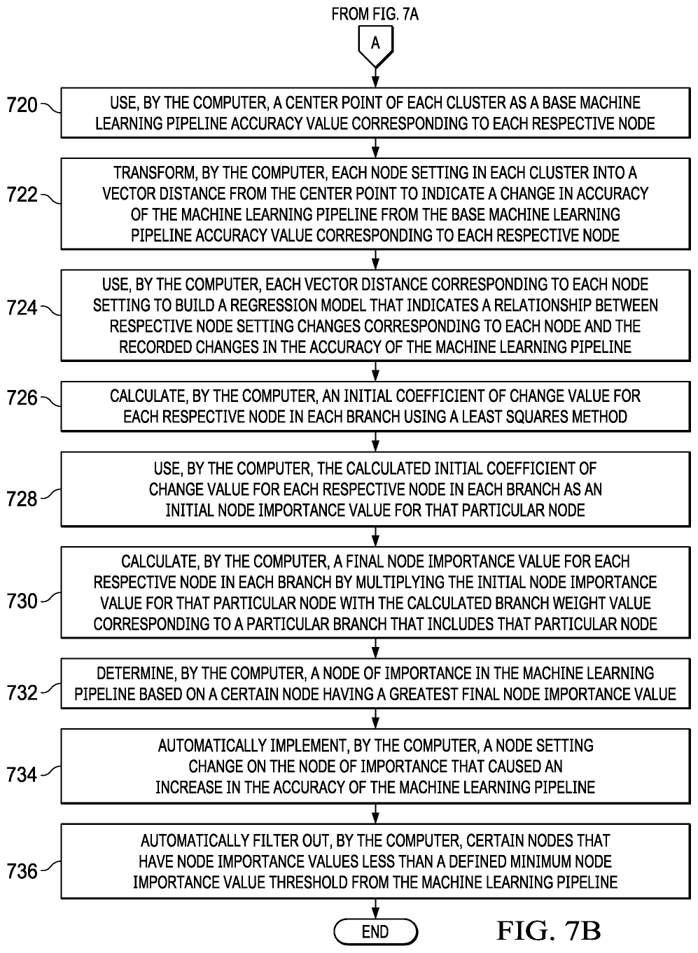

With reference now to FIGS. 7A-7B, a flowchart illustrating a process for implementing a node setting change on a node of importance in a machine learning pipeline is shown in accordance with an illustrative embodiment. The process shown in FIGS. 7A-7B may be implemented in a computer, such as, for example, server 106 in FIG. 1 or data processing system 200 in FIG. 2. For example, the process shown in FIGS. 7A-7B may be implemented in machine learning pipeline manager 218 in FIG. 2.

The process begins when the computer divides a machine learning pipeline comprised of a plurality of nodes into a plurality of branches, each branch comprised of a plurality of nodes that includes a machine learning model building node (step 702). In addition, the computer determines a number of the plurality of nodes that comprise the machine learning pipeline (step 704).

Further, the computer determines a node weight value for each respective node of the plurality of nodes based on a default node weight value and a number of machine learning model building nodes that each respective node is connected to in the machine learning pipeline (step 706). Furthermore, the computer calculates a branch weight value for each respective branch of the plurality of branches in the machine learning pipeline by adding node weight values in each particular branch and dividing a sum of the node weight values for each particular branch by the number of the plurality of nodes that comprise the machine learning pipeline (step 708).

Moreover, the computer determines a range of values for all randomly generated node settings for each respective branch of nodes (step 710). Afterward, the computer randomly generates a defined number of different groups of node settings for each branch of nodes within the determined range of values for all randomly generated node settings for each respective branch of nodes (step 712). The computer records changes in accuracy of the machine learning pipeline for each of the defined number of different groups of node settings input into each branch of nodes (step 714).

The computer uses a group of node settings for each respective node as one cluster for one particular node (step 716). The computer calculates center points for each cluster corresponding to the group of node settings for each respective node (step 718). The computer uses a center point of each cluster as a base machine learning pipeline accuracy value corresponding to each respective node (step 720).

The computer transforms each node setting in each cluster into a vector distance from the center point to indicate a change in accuracy of the machine learning pipeline from the base machine learning pipeline accuracy value corresponding to each respective node (step 722). The computer uses each vector distance corresponding to each node setting to build a regression model that indicates a relationship between respective node setting changes corresponding to each node and the recorded changes in the accuracy of the machine learning pipeline (step 724).

In addition, the computer calculates an initial coefficient of change value for each respective node in each branch using a least squares method (step 726). The computer uses the calculated initial coefficient of change value for each respective node in each branch as an initial node importance value for that particular node (step 728). Further, the computer calculates a final node importance value for each respective node in each branch by multiplying the initial node importance value for that particular node with the calculated branch weight value corresponding to a particular branch that includes that particular node (step 730).

Afterward, the computer determines a node of importance in the machine learning pipeline based on a certain node having a greatest final node importance value (step 732). The computer automatically implements a node setting change on the node of importance that caused an increase in the accuracy of the machine learning pipeline (step 734). The computer also automatically filters out certain nodes that have node importance values less than a defined minimum node importance value threshold from the machine learning pipeline (step 736). Thereafter, the process terminates.

Thus, illustrative embodiments of the present invention provide a computer-implemented method, computer system, and computer program product for determining the relationship between changes in node settings of nodes comprising a machine learning pipeline and changes in accuracy and performance of the machine learning pipeline to identify node importance in the machine learning pipeline. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for identifying node importance in a machine learning pipeline, the computer-implemented method comprising:
recording, by a computer, changes in accuracy of the machine learning pipeline for each respective node setting change in a randomly generated group of node settings inputted into each corresponding node included in the machine learning pipeline;
generating, by the computer, a regression model to determine a relationship between each respective node setting change in the randomly generated group of node settings inputted into each corresponding node and the changes in the accuracy of the machine learning pipeline; and
identifying, by the computer, a node of importance in the machine learning pipeline using the regression model based on the relationship between each respective node setting change in the randomly generated group of node settings inputted into each corresponding node and the changes in the accuracy of the machine learning pipeline.

2. The computer-implemented method of claim 1 further comprising:
implementing, by the computer, a node setting change automatically on the node of importance that caused an increase in the accuracy of the machine learning pipeline.

3. The computer-implemented method of claim 1 further comprising:
receiving, by the computer, an input to determine the node of importance in the machine learning pipeline comprised of a plurality of nodes from a client device of a user via a network;
randomly generating, by the computer, a group of node settings for each respective node of the machine learning pipeline in response to receiving the input to determine the node of importance in the machine learning pipeline; and
inputting, by the computer, each randomly generated group of node settings into a corresponding node of the machine learning pipeline.

4. The computer-implemented method of claim 1 further comprising:
dividing, by the computer, the machine learning pipeline comprised of a plurality of nodes into a plurality of branches, each branch comprised of a plurality of nodes that includes a machine learning model building node;
determining, by the computer, a number of the plurality of nodes that comprise the machine learning pipeline; and
determining, by the computer, a node weight value for each respective node of the plurality of nodes based on a default node weight value and a number of machine learning model building nodes that each respective node is connected to in the machine learning pipeline.

5. The computer-implemented method of claim 4 further comprising:
calculating, by the computer, a branch weight value for each respective branch of the plurality of branches in the machine learning pipeline by adding node weight values in each particular branch and dividing a sum of the node weight values for each particular branch by the number of the plurality of nodes that comprise the machine learning pipeline.

6. The computer-implemented method of claim 5 further comprising:
determining, by the computer, a range of values for all randomly generated node settings for each respective branch of nodes;
randomly generating, by the computer, a defined number of different groups of node settings for each branch of nodes within the range of values for all randomly generated node settings for each respective branch of nodes; and
recording, by the computer, the changes in the accuracy of the machine learning pipeline for each of the defined number of different groups of node settings input into each branch of nodes.

7. The computer-implemented method of claim 6 further comprising:
using, by the computer, a group of node settings for each respective node as one cluster for one particular node;
calculating, by the computer, center points for each cluster corresponding to the group of node settings for each respective node; and
using, by the computer, a center point of each cluster as a base machine learning pipeline accuracy value corresponding to each respective node.

8. The computer-implemented method of claim 7 further comprising:
transforming, by the computer, each node setting in each cluster into a vector distance from the center point to indicate a change in accuracy of the machine learning pipeline from the base machine learning pipeline accuracy value corresponding to each respective node; and
using, by the computer, each vector distance corresponding to each node setting to build the regression model that indicates the relationship between respective node setting changes corresponding to each node and the changes in the accuracy of the machine learning pipeline.

9. The computer-implemented method of claim 8 further comprising:
calculating, by the computer, an initial coefficient of change value for each respective node in each branch using a least squares method;
using, by the computer, the initial coefficient of change value for each respective node in each branch as an initial node importance value for that particular node; and
calculating, by the computer, a final node importance value for each respective node in each branch by multiplying the initial node importance value for that particular node with the branch weight value corresponding to a particular branch that includes that particular node.

10. The computer-implemented method of claim 9 further comprising:
determining, by the computer, the node of importance in the machine learning pipeline based on a certain node having a greatest final node importance value; and
implementing, by the computer, a node setting change automatically on the node of importance that caused an increase in the accuracy of the machine learning pipeline.

11. The computer-implemented method of claim 9 further comprising:
filtering out automatically, by the computer, certain nodes that have node importance values less than a defined minimum node importance value threshold from the machine learning pipeline.

12. A computer system for identifying node importance in a machine learning pipeline, the computer system comprising:
a bus system;
a storage device connected to the bus system, wherein the storage device stores program instructions; and
a processor connected to the bus system, wherein the processor executes the program instructions to:
record changes in accuracy of the machine learning pipeline for each respective node setting change in a randomly generated group of node settings inputted into each corresponding node included in the machine learning pipeline;
generate a regression model to determine a relationship between each respective node setting change in the randomly generated group of node settings inputted into each corresponding node and the changes in the accuracy of the machine learning pipeline; and
identify a node of importance in the machine learning pipeline using the regression model based on the relationship between each respective node setting change in the randomly generated group of node settings inputted into each corresponding node and the changes in the accuracy of the machine learning pipeline.

13. The computer system of claim 12, wherein the processor further executes the program instructions to:
implement a node setting change automatically on the node of importance that caused an increase in the accuracy of the machine learning pipeline.

14. A computer program product for identifying node importance in a machine learning pipeline, the computer program product comprising a computer-readable storage medium having program instructions embodied therewith, the program instructions executable by a computer to cause the computer to perform a method of:
recording, by the computer, changes in accuracy of the machine learning pipeline for each respective node setting change in a randomly generated group of node settings inputted into each corresponding node included in the machine learning pipeline;
generating, by the computer, a regression model to determine a relationship between each respective node setting change in the randomly generated group of node settings inputted into each corresponding node and the changes in the accuracy of the machine learning pipeline; and
identifying, by the computer, a node of importance in the machine learning pipeline using the regression model based on the relationship between each respective node setting change in the randomly generated group of node settings inputted into each corresponding node and the changes in the accuracy of the machine learning pipeline.

15. The computer program product of claim 14 further comprising:
implementing, by the computer, a node setting change automatically on the node of importance that caused an increase in the accuracy of the machine learning pipeline.

16. The computer program product of claim 15 further comprising:
receiving, by the computer, an input to determine the node of importance in the machine learning pipeline comprised of a plurality of nodes from a client device of a user via a network;
randomly generating, by the computer, a group of node settings for each respective node of the machine learning pipeline in response to receiving the input to determine the node of importance in the machine learning pipeline; and
inputting, by the computer, each randomly generated group of node settings into a corresponding node of the machine learning pipeline.

17. The computer program product of claim 16 further comprising:
dividing, by the computer, the machine learning pipeline comprised of a plurality of nodes into a plurality of branches, each branch comprised of a plurality of nodes that includes a machine learning model building node;
determining, by the computer, a number of the plurality of nodes that comprise the machine learning pipeline; and
determining, by the computer, a node weight value for each respective node of the plurality of nodes based on a default node weight value and a number of machine learning model building nodes that each respective node is connected to in the machine learning pipeline.

18. The computer program product of claim 17 further comprising:
calculating, by the computer, a branch weight value for each respective branch of the plurality of branches in the machine learning pipeline by adding node weight values in each particular branch and dividing a sum of the node weight values for each particular branch by the number of the plurality of nodes that comprise the machine learning pipeline.

19. The computer program product of claim 18 further comprising:
determining, by the computer, a range of values for all randomly generated node settings for each respective branch of nodes;
randomly generating, by the computer, a defined number of different groups of node settings for each branch of nodes within the range of values for all randomly generated node settings for each respective branch of nodes; and
recording, by the computer, the changes in the accuracy of the machine learning pipeline for each of the defined number of different groups of node settings input into each branch of nodes.

20. The computer program product of claim 19 further comprising:
using, by the computer, a group of node settings for each respective node as one cluster for one particular node;
calculating, by the computer, center points for each cluster corresponding to the group of node settings for each respective node; and
using, by the computer, a center point of each cluster as a base machine learning pipeline accuracy value corresponding to each respective node.
